(19) United States
(12) Patent Application Publication
(10) Pub. No.: US 2005/0239355 A1
(43) Pub. Date: Oct. 27, 2005

(54) Formable play material and a method for producing the same

(76) Inventor: Geoffrey J. Bennett, Portland, OR (US)

Correspondence Address: Carl D. Crowell, P.O. Box 923, Salem, OR, 97308, US

(21) Appl. No.: 10/832,888

(22) Filed: Apr. 26, 2004

(51) Int. Cl. B32B 27/12; B32B 27/04; B32B 13/02; B32B 13/14; B29D 1/00; B32B 5/02

(52) U.S. Cl. 442/43; 442/6; 442/49; 442/20; 442/42; 442/38

(57) ABSTRACT

A formable play material is constructed from pouring a melted plastiline clay material over a nylon mesh sheet creating a nylon reinforced sheet of pliable clay. The formable play material has improved moldability due to the reinforcement and is easily reshaped and welded together by pinching and pressure.

### FIELD OF THE INVENTION

The present invention relates to formable play material compositions and particularly to formable materials used for modeling play structures and roadways.

### BACKGROUND OF THE INVENTION

Play compositions of different types have been provided by practitioners in the toy arts through the years to amuse children and adults and to aid in the development of manual skills and dexterity as well as creativity. While the variety of such play material compositions is virtually endless, all generally involve the use of free-forming or malleable materials such as oil base or water base gums and gel compounds which may be manipulated and shaped by the user. Certain materials have been provided which are moldable or formable and tend to retain their shapes such as modeling clay or the like. Others, however, have been provided which are looser and more free-flowing such as novelty play material and compositions.

Regardless of the type of play material compounds used, those using these products typically prefer materials that are easily shaped without cracking or crumbling, stay pliable for alterations, and can be reformed into future projects.

The continuing need for evermore improved and varied play material compositions has prompted practitioners in the art to develop a great number of such materials. For example, U.S. Pat. No. 3,804,754 issued to Liu sets forth a MODELING COMPOSITION formed of material fillers such as clay and talc together with hydrocarbon petroleum distillate oil, waxy paraffinic hydrocarbon oil, a liquid silicone compound, an astringent, a humectant, glue and water. The composition is moldable and shapeable when initially mixed and properly stored but ultimately takes a permanent set after a predetermined cure time.

U.S. Pat. No. 4,172,054 issued to Ogawa, et al. sets forth a MODELING COMPOSITION FOR CRAFT WORKS AND A METHOD FOR THE PRODUCTION THEREFOR in which an improved modeling compound of a soft pliable working consistency formable into any desired shape is provided which is relatively fast drying to assume a permanent shape. A small amount of dibutyl hydroxyl-toluene or butyl hydroxyanisole or both is included in the composition.

U.S. Pat. No. 4,735,660 issued to Cane sets forth a CROSS-LINKED GEL MODELING COMPOSITION capable of assuming various colors which is cohesively strong but pliable and ductile. The compound is formed by combining a wood flower to a water-based gel using cross linkable guar gum as a gallant.

U.S. Pat. No. 5,310,420 issued to Shapero, et al. sets forth a PLAY MATERIAL which is formed using a self-cross-linking sodium alginate combined with germaben II-E and butylparaben preservatives. The play material exhibits improved preservative action and avoidance of eye and skin irritation problems on the part of the user.

While certain of the foregoing described play material compositions have enjoyed some commercial success and provided amusement and entertainment, there remains a continuing need in the art for evermore improved and varied play material compositions that are also easily and inexpensively manufactured.

### SUMMARY OF THE INVENTION

Disclosed is a reinforced play material composition. The play material is made from a plastiline clay which in the preferred embodiment is a mixture of microcrystalline wax, #10 weight oil, automotive grease, and dry clay powder. The wax, oil and grease are heated together until melted. This mixture is poured over a nylon mesh sheet creating a sheet of nylon reinforced forming clay of a desired thickness.

The primary object of the invention is the provision of a play material that is formable while sufficiently reinforced thereby eliminating tearing during construction.

Another object of the present invention is the provision of a play material that is produced and sold in sheets thereby minimizing manufacturing costs as well as providing a more easy to handle play material.

### BRIEF DESCRIPTION OF THE DRAWINGS

FIG. 1 is a plan view of the present invention illustrating the layered form of the preferred embodiment of the present invention;

FIG. 2 is a plan view of an application using the preferred embodiment of the present invention; and

FIG. 3 sets forth a flow diagram of the process for manufacturing the preferred embodiment of the present invention play material.

The above description and other objects, advantages, and features of the present invention will be more fully understood and appreciated by reference to the specification and accompanying drawings.

### DETAILED DISCUSSION OF THE PREFERRED EMBODIMENTS

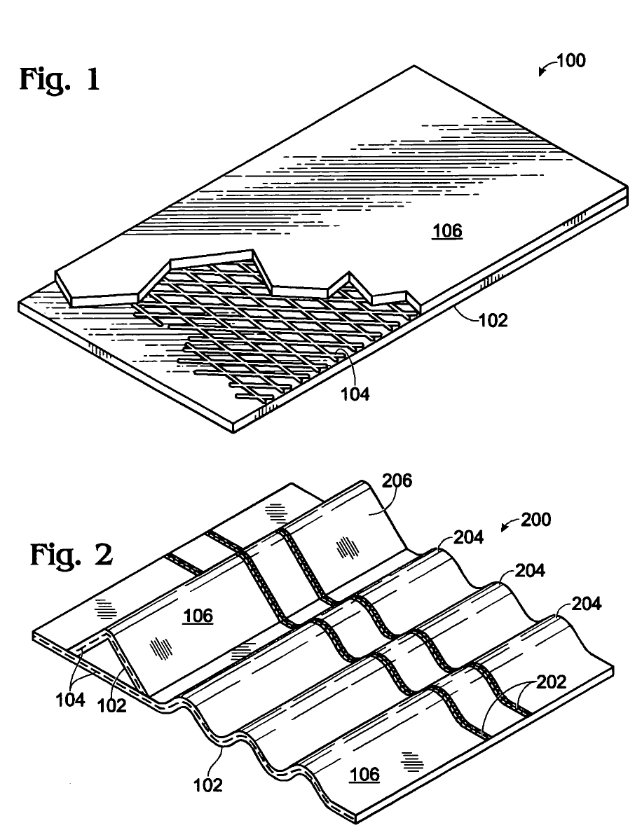

Referring to the figures, like elements retain their indicators throughout the several views. FIG. 1 is a plan view of the present invention illustrating the layered form of the preferred embodiment of the present invention. In the preferred embodiment, the formable play material is manufactured and sold in sheets that can be cut, bent, or formed in many ways to create structures, roads, or other desired shapes. As illustrated in the cut away corner of FIG. 1, Sheet 100 is composed of Top Layer 106, Bottom Layer 102, and Reinforcing Mesh 104 disposed between Top Layer 106 and Bottom Layer 102. To create the preferred embodiment, a plastiline clay is heated and poured over Reinforcing Mesh 104 creating a three layered, pliable sheet of mesh reinforced modeling clay. Plastiline, or oil-based modeling clay, is basically clay powder mixed with oil and wax instead of water. Its advantage over water-based, or potter's clay, is that it stays workable for long periods of time, instead of drying and shrinking as it does so. One recipe for plastiline clay is set forth in Table 1.

TABLE 1

| INGREDIENT | QUANTITY | |
|---|---|---|
| Microcrystalline Wax | 10 | Pounds |
| #10 Weight Oil | ½ | Gallon |
| Automotive Grease | 4 | Pounds |
| Dry Clay Powder | 25 | Pounds |

Melt wax, oil, and grease together in an electric frying kettle. Stir the clay in slowly once the wax, oil and grease are all melted. Next, pour the mixture into shallow microwave-safe plastic containers, or into a wet plaster mold. This basic recipe may be modified for specific applications. Beeswax may be used for part of the wax component. Petroleum jelly may be used for the grease. Purified mineral oil may be substituted for the 10 weight motor oil. Using these alternatives, the moldable material smells better and does not have a problem with the rubber mold compounds. Varying the proportions of the constituents slightly will yield harder or softer clays.

Sheet 100 is intended to stay soft and pliable so it may be reshaped or welded together through pinching and pressure, or layered over existing mold forms. If Sheet 100 begins to lose pliability or to firm up, it may be resoftened with the application of heat.

Although in the preferred embodiment a plastiline clay is used with a nylon Reinforcing Mesh 104, other embodiments include traditional clay or adobe with a wire, Kevlar®, or fiberglass mesh which may be fired to form a durable finished form structure, or designed to be used wet and allowed to dry.

In the preferred embodiment, Sheet 100 is produced by melting the plastiline clay. It is also contemplated that Sheet 100 be manufactured by spraying the clay of choice onto and through Reinforcing Mesh 104 creating Sheet 100. Additionally, Sheet 100 may be produced by an injection molding process.

In yet another embodiment, with the addition of dye to the manufacturing process, Sheet 100 is produced in a variety of colors eliminating the need to paint the finished shape in particular applications.

FIG. 2 is a plan view of an application using the preferred embodiment of the present invention. Moto-cross Track Section 200 is created by forming multiple Sheet 100's to make Formed Vehicle Jump 206 which is attached to Rough Road Section 204. In this application, the formable play material is referred to as “MotoMud.” The pliability of the MotoMud creates a very realistic moto-cross track as it allows Vehicle Tire Tracks 202 to be visible after traveling over Moto-cross Track Section 200. Vehicle Tire Tracks 202 are easily removed by rolling with a rolling pin or by pressure applied with hands and fingers. The advantages of MotoMud is that it is highly reshapable, the clay surface provides a close simulation to a dirt-like race track, is relatively easy to work with, and it is clean.

Alternate uses of the invention include the formed sheets being useful as a building component in any manner that sheets of mud or clay may be used including traditional ceramics or as a mud surfacing in non-toy construction. In these applications, large format pieces are used to provide quick and efficient installation of mud and plaster siding for full scale building structures.

Although the terrain modeling shown in FIG. 2 is for a toy motocross application, it is also contemplated that the present invention is applicable for non-toy or full-sized motocross terrain modeling.

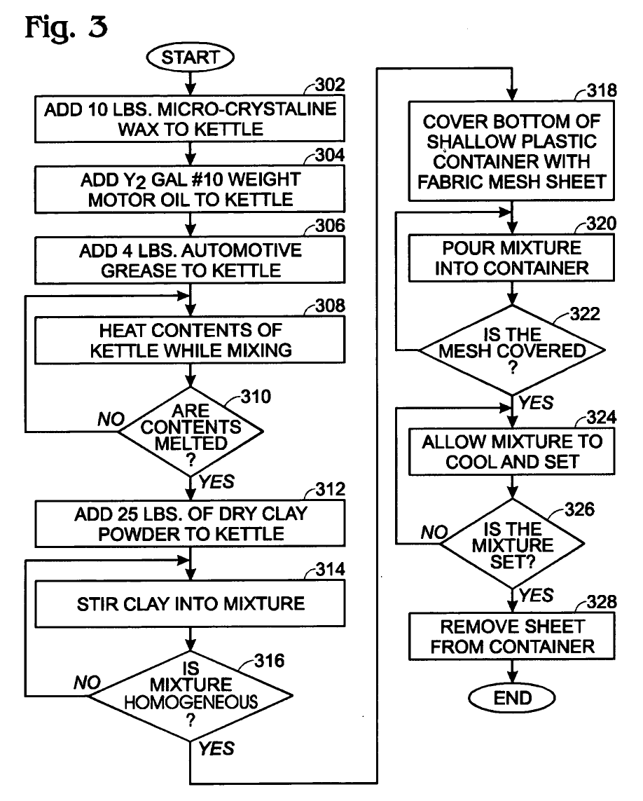

FIG. 3 sets forth a flow diagram of the process for manufacturing the preferred embodiment of the formable play material of the present invention. In Block 302, 10 pounds of Microcrystalline Wax is added to an electric frying kettle. In Block 304, V₂ gallon of 10 Weight Motor Oil is added to the kettle with the Wax. In Block 306, four pounds of Automotive Grease is added to the kettle with the Wax and Oil. In Block 308, the contents of the kettle is heated while being mixed. Block 310 queries as to whether or not the contents of the kettle are all melted. If the contents are not melted, control returns to Block 308 where the contents of the kettle are being heated and mixed. If the contents are melted, control moves to Block 312 where 25 pounds of Dry Clay Powder is added to the kettle. In Block 314, the Clay Powder is mixed into the melted Wax, Oil, and Grease. Block 316 queries as to whether or not the mixture is homogeneous. If it is not homogeneous, control returns to Block 314 where the Clay is being mixed into the contents of the kettle. If the mixture is homogeneous, control moves to Block 318 where the bottom of a plastic container is covered with a Mesh Sheet. In the preferred embodiment, the Mesh Sheet is made of nylon. However, depending upon the application, fabric, plastic, or even wire mesh may be used.

In Block 320, the homogeneous clay mixture is poured into the container with the mesh covering the bottom of it. The mixture will flow under and around the mesh so that the mesh will be somewhat in the center of the mixture. Block 322 queries as to whether or not the mesh is covered. If not covered, control returns to Block 320 where the mixture continues to be poured into the container over the mesh. If the mesh is covered, control moves to Block 324 where the mixture is allowed to cool thereby setting up to a firm yet pliable clay. Block 326 queries the status of the mixture. If it is not set up firm enough to be removed from the container, control returns to Block 324 where the mixture is allowed to cool and set. If the mixture is set up, control moves to Block 328 and the formed sheet is removed from the container.

Although the aforementioned process is primarily directed to the production of sheets of MotoMud, it is contemplated that the same process can be applied to larger applications, making larger sheets of construction material for non-play construction applications.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

1. A construction material comprising:
a first layer of pliable clay of a length and a width;
a second layer of pliable clay of said length and said width; and
a mesh sheet of said length and said width; wherein said mesh sheet is disposed between said first layer and said second layer forming a single sheet of the construction material having said length and said width.

2. The construction material of claim 1, wherein said mesh sheet is nylon mesh.

3. The construction material of claim 1, wherein said mesh sheet is wire mesh.

4. The construction material of claim 1, wherein said mesh sheet is fiberglass mesh.

5. The construction material of claim 1, wherein said mesh sheet is Kevlar® mesh.

6. The construction material of claim 1, wherein said first layer and said second layer is plastiline clay.

7. The construction material of claim 1, wherein said first layer and said second layer is water-based clay.

8. A construction material comprising:
approximately 10 pounds of a microcrystalline wax;
approximately 64 ounces of a #10 weight oil;
approximately 4 pounds of an automotive grease;
approximately 25 pounds of a dry clay powder; and
a mesh sheet, wherein said wax, said oil, and said grease are mixed together in a kettle and heated until melted, said clay powder is added to the kettle and mixed until a homogeneous mixture is formed, said mesh sheet is placed in the bottom of a shallow container and the mixture is poured over said mesh sheet to a desired thickness.

9. The construction material of claim 8, wherein said mesh sheet is nylon mesh.

10. The construction material of claim 8, wherein said mesh sheet is wire mesh.

11. The construction material of claim 8, wherein said mesh sheet is fiberglass mesh.

12. The construction material of claim 8, wherein said mesh sheet is Kevlarg mesh.

13. A method of manufacturing a formable construction material, comprising the steps of:
adding approximately 10 pounds of a micro-crystalline wax to a kettle;
adding approximately one-half gallon of a #10 weight motor oil to said kettle;
adding approximately four pounds of an automotive grease to said kettle;
heating contents of said kettle until said wax, said oil, and said grease are all melted;
adding approximately 25 pounds of a dry clay powder to said kettle;
stirring contents of said kettle until said wax, said oil, said grease, and said powder become a homogeneous mixture;
covering a bottom surface of a container with a mesh sheet;
pouring said homogeneous mixture into said container covering said mesh sheet;
allowing said homogeneous mixture to cool; and
removing said homogeneous mixture from said container.
